(19) United States
(12) Patent Application Publication
(10) Pub. No.: US 2026/0251808 A1
(43) Pub. Date: Aug. 27, 2026

(54) APPARATUS FOR CLASSIFYING RADIOACTIVE WASTE, AND SYSTEM FOR CLASSIFYING NUCLEAR FACILITY DISMANTLEMENT WASTE COMPRISING SAME

(71) Applicant: BNS CO., LTD., Osan-si, Gyeonggi-do (KR)

(72) Inventors: Myung Jin KIM, Uijeongbu-si, Gyeonggi-do (KR); Dae Seok HONG, Daejeon (KR); Yun Ho CHO, Bucheon-si, Gyeonggi-do (KR); Jong Weon KIM; Tae Young KIM, Hwaseong-si, Gyeonggi-do (KR)

(73) Assignee: BNS CO., LTD., Osan-si, Gyeonggi-do (KR)

(21) Appl. No.: 18/714,432

(22) PCT Filed: May 25, 2022
(86) PCT No.: PCT/KR2022/007440

§ 371 Date: May 29, 2024

(30) Foreign Application Priority Data
Nov. 29, 2021 (KR) 10-2021-0167673

(51) Int. Cl. G01T 1/167; G01T 7/08; G21F 9/00

(52) U.S. Cl. CPC G01T 1/167; G01T 7/08; G21F 9/001

(57) ABSTRACT

The present invention relates to an apparatus for classifying radioactive waste and a system for classifying nuclear facility dismantlement waste, wherein the system comprises the apparatus. The apparatus for classifying radioactive waste may comprise: a first inspection module provided to measure whether the radiation emitted by an inspection target is less than or equal to a predetermined first reference amount while the inspection target moves along a first direction perpendicular to the up/down direction; and a second inspection module provided to re-examine the inspection target when the radiation emitted by the inspection target and measured by the first inspection module is less than or equal to the first reference amount, and measure whether the radiation emitted by the inspection target is equal to or less than a second reference amount smaller than the first reference amount.

### TECHNICAL FIELD

The present disclosure relates to an apparatus for classifying radioactive waste, and a system for classifying nuclear facility dismantlement waste including the same.

### BACKGROUND ART

In general, radioactive waste, from which various radioactive substances are discharged, is generated during nuclear facility decommissioning projects. Various types of radioactive waste generated during the dismantling process are generated in large quantities in a short period of time, and thus, it is very important to manage it efficiently.

In the case of Korea, according to Nuclear Safety and Security Commission Notice No. 2020-6, ‘Regulations on radioactive waste classification and self-disposal standards’, radioactive waste that satisfies an allowable concentration and an allowable dose for self-disposal may be self-disposed, and the waste that is to be self-disposed has to be separated and stored separately to prevent other waste from being mixed.

Conventionally, it is determined whether radioactive waste satisfies an allowable concentration and an allowable dose for self-disposal by performing a single precise inspection. That is, it is determined whether all radioactive waste satisfies the allowable concentration and dose for self-disposal through one precise inspection, but this precise inspection takes a long time, and thus, the overall radioactive waste classification speed is slowed down.

In addition, conventionally, it is measured whether the radioactive waste satisfies the allowable concentration and dose for self-disposal while the radioactive waste is fed by using a conveyor belt scheme. This conventional conveyor belt method had a problem in that it was impossible to finely control the position of radioactive waste, making precise measurement difficult.

### DISCLOSURE

### Technical Problem

An aspect of the present disclosure provides an apparatus for classifying radioactive waste with an improved radioactive waste classification speed, and a system for classifying nuclear facility dismantlement waste including the same.

An aspect of the present disclosure also provides an apparatus for classifying radioactive waste that may finely control a position of radioactive waste, and a system for classifying nuclear facility dismantlement waste including the same.

### Technical Solution

According to an aspect of the present disclosure, an apparatus for classifying radioactive waste, the apparatus includes a first inspection module that measures whether an amount of radiation emitted by an inspection target is less than or equal to a first reference amount while the inspection target is moved along a first direction being one direction being perpendicular to an up/down direction, and a second inspection module that measures whether an amount of radiation emitted by the inspection target is less than or equal to a second reference amount being smaller than the first reference amount by re-inspecting the inspection target when the amount of the radiation emitted by the inspection target, which is measured by the first inspection module, is less than or equal to the first reference amount.

In another example, the first inspection module may include a first module body extending along the first direction, and including a first inspection passage configured such that the inspection target passes through an interior thereof, and a first sensor part located a side of the first inspection passage in the first direction, and that measures the amount of the radiation emitted by the inspection target.

In another example, the first sensor part may include a plurality of first sensor members arranged along a second direction being one direction being perpendicular to the up/down direction and the first direction.

In another example, the first sensor part may include a (1-1)-th sensor member, and a (1-2)-th sensor member having an energy resolution being higher than that of the (1-1)-th sensor member.

In another example, the first inspection module may further include a first shield part covering the first module body, and that shields external radioactive rays from being introduced to an inside of the first module body.

In another example, the second inspection module may be configured to locate the inspection target in a second reference area in an interior of the second inspection module for a reference time period to measure an amount of radiation emitted by the inspection target for the reference time period is less than or equal to the second reference amount.

In another example, the apparatus may further include a pallet configured such that the inspection target is seated thereon, and a rail part configured such that the pallet is seated thereon to be movable.

In another example, the apparatus may further include a motor part coupled to the pallet and that moves the pallet, and the motor part may be configured to move the pallet at a first movement speed before the pallet or the inspection target seated on the pallet is located in a first reference area in an interior of the first inspection module, and move the pallet at a second movement speed being lower than the first movement speed when the pallet or the inspection target seated on the pallet is located in the first reference area.

In another example, the rail part may include a first rail extending in the first direction, and to which the first inspection module is coupled, a second rail extending along the first direction from a distal end of the first rail in the first direction, a third rail extending along a second direction being one direction being perpendicular to the up/down direction and the first direction from a distal end of the second rail in the first direction, a fourth rail extending along an opposite direction to the first direction from a distal end of the third rail in the second direction, and a fifth rail extending in an opposite direction to the second direction from a distal end of the fourth rail in an opposite direction to the first direction, connected to the distal end of the first rail in the first direction, and to which the second inspection module is coupled.

In another example, the apparatus may further include a storage part located on a side of the third rail in the first direction to be spaced apart from the third rail, and that stores the inspection target, of which the amount of the radiation has been measured, and a feeding crane disposed between the third rail and the storage part, and that feeds the inspection target seated on the pallet located on the third rail to the storage part.

In another example, the storage part may include a first storage area that stores, among the inspection targets, an inspection target, of which an amount of emitted radiation is more than the second reference amount, and a second storage area that stores, among the inspection targets, an inspection target, of which an amount of emitted radiation is less than or equal to the second reference amount.

In another example, when the amount of radiation emitted by the inspection target seated on the pallet, which is measured by the first inspection module, is more than the first reference amount when the pallet passes by the first rail, the inspection target may be stored in the first storage area through the feeding crane after being seated on the pallet and passing by the second rail.

In another example, when the amount of the radiation emitted by the inspection target seated on the pallet, which is measured by the first inspection module, is less than or equal to the first reference amount when the pallet passes by the first rail, the inspection target may be seated on the pallet and pass by the second rail, the third rail, the fourth rail, and the fifth rail, and the second inspection module may measure whether the amount of radiation emitted by the inspection target is less than or equal to the second reference amount when the inspection target passes by the fifth rail.

In another example, when the amount of the radiation emitted by the inspection target, which is measured by the second inspection module, is more than the second reference amount, the inspection target may be stored in the first storage area through the feeding crane after being seated on the pallet and passing by the second rail.

In another example, when the amount of the radiation emitted by the inspection target, which is measured by the second inspection module, is less than or equal to the second reference amount, the inspection target may be stored in the second storage area through the feeding crane after being seated on the pallet and passing by the second rail.

In another example, the rail part may further include a sixth rail extending in an opposite direction to the first direction from a distal end of the fourth rail in the opposite direction to the first direction, and a seventh rail extending in an opposite direction to the second direction from a distal end of the sixth rail in the opposite direction to the first direction, and connected to the first rail, and the pallet having delivered the inspection target to the feeding crane may be moved to the first rail via the fourth rail, the sixth rail, and the seventh rail.

In another example, the apparatus may further include a decontamination part coupled to the rail part, and that decontaminates the inspection target seated on the pallet.

According to another aspect of the present disclosure, a system for classifying nuclear facility dismantlement waste includes a radioactive waste classifying apparatus that measures an amount of radiation of nuclear facility dismantlement waste being waste generated when a nuclear facility is dismantled to classify the nuclear facility dismantlement waste, and a controller that controls the radioactive waste classifying apparatus, and the radioactive waste classifying apparatus may include a first inspection module that measures whether an amount of the radiation emitted by the nuclear facility dismantlement waste is less than or equal to a first reference amount, a second inspection module that measures whether the amount of the radiation emitted by the nuclear facility dismantlement waste is less than or equal to a second reference amount being smaller than the first reference amount by re-inspecting the nuclear facility dismantlement waste when the amount of the radiation emitted by the nuclear facility dismantlement waste, which is measured by the first inspection module, is less than or equal to the first reference amount, and a storage part that classifies and store the nuclear facility dismantlement waste based on inspection results of the first inspection module and the second inspection module.

### Advantageous Effects

According to the present disclosure, the radioactive waste classification speed may be improved by primarily performing a high-speed inspection and secondarily performing a precision inspection based on the results of the high-speed inspection.

In addition, according to the present disclosure, because the radioactive waste is moved by using a linear motor scheme, it is possible to finely control the position of the radioactive waste and perform a precise measurement.

### DESCRIPTION OF DRAWINGS

FIG. 1 is a view conceptually illustrating a process of processing radioactive waste through an apparatus for classifying radioactive waste according to an embodiment of the present disclosure.

FIG. 2 is a perspective view of an apparatus for classifying radioactive waste according to an embodiment of the present disclosure.

FIG. 3 is a top view of an apparatus for classifying radioactive waste according to an embodiment of the present disclosure.

FIG. 4 is a perspective view of a first inspection module.

FIG. 5 is a top view of a first inspection module.

FIG. 6 is a perspective view of a second inspection module.

FIG. 7 is a top view of a second inspection module.

FIG. 8 is a perspective view illustrating a roller.

FIG. 9 is a view illustrating a case, in which an inspection target is not in a first reference area.

FIG. 10 is a view illustrating a case, in which an inspection target is in a first reference area.

FIG. 11 is a view illustrating a movement path of a pallet when an amount of radiation of an inspection target is more than a first reference amount.

FIG. 12 is a view illustrating a movement path of a pallet when an amount of radiation of an inspection target is less than or equal to a first reference amount.

FIG. 13 is a view illustrating a movement path of a pallet when an amount of radiation of an inspection target is more than a second reference amount.

FIG. 14 is a view illustrating a movement path of a pallet when an amount of radiation of an inspection target is less than or equal to a second reference amount.

FIG. 15 is a view illustrating a movement path of a pallet after an inspection target has been stored.

### MODE FOR INVENTION

This application claims the benefit of priority to Korean Patent Application No. 10-2021-0167673, filed in the Korean Intellectual Property Office on Nov. 29, 2021, the entire contents of which are incorporated herein by reference.

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

### Apparatus for Classifying Radioactive Waste

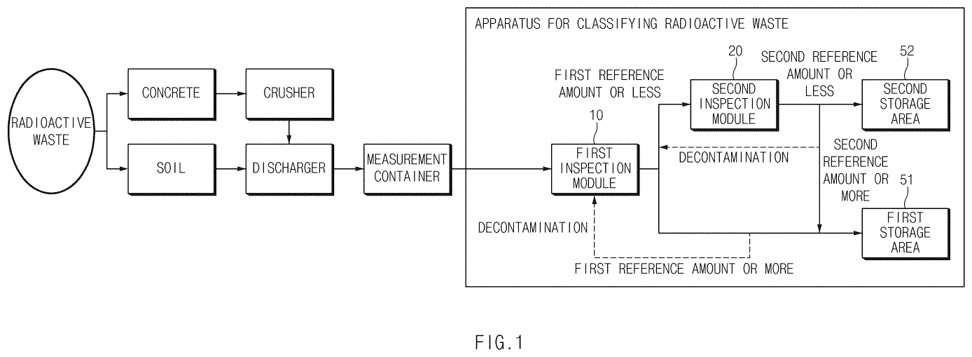

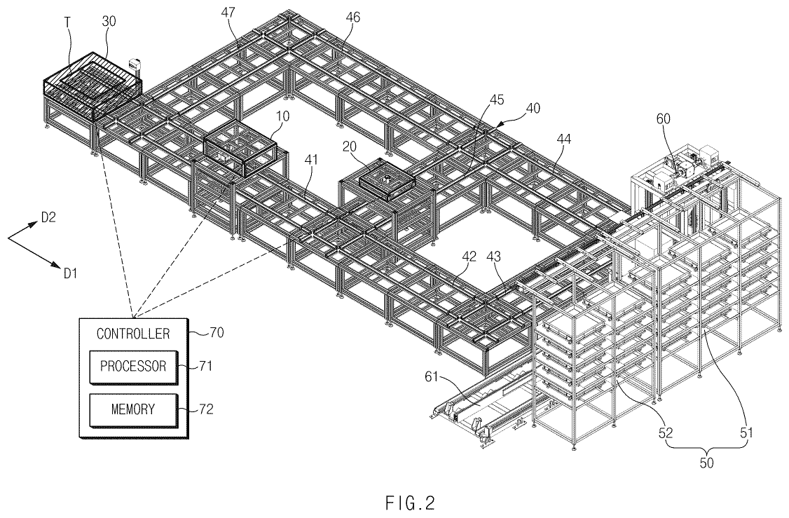

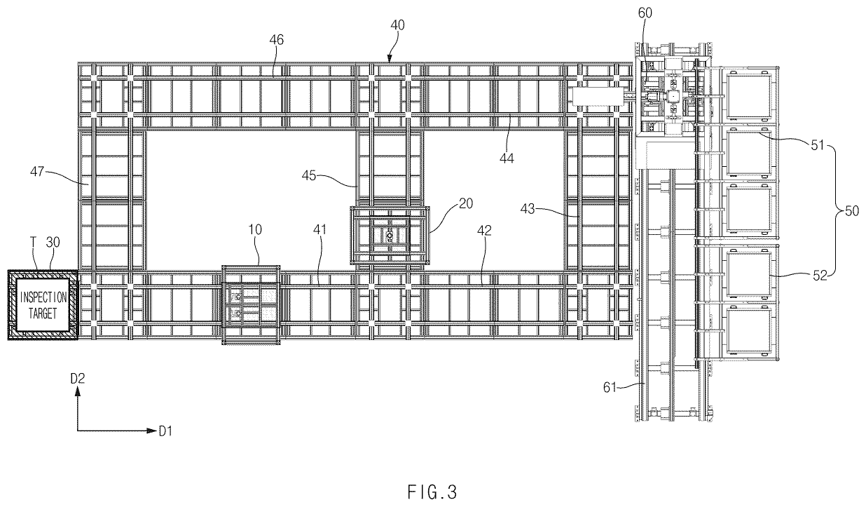

FIG. 1 is a view conceptually illustrating a process of processing radioactive waste through an apparatus for classifying radioactive waste according to an embodiment of the present disclosure. FIG. 2 is a perspective view of the apparatus for classifying radioactive waste according to an embodiment of the present disclosure. FIG. 3 is a top view of the apparatus for classifying radioactive waste according to an embodiment of the present disclosure.

An apparatus for classifying radioactive waste according to an embodiment of the present disclosure may be an apparatus that classifies radioactive waste based on an amount of radiation of radioactive waste. As an example, radioactive waste may be nuclear facility dismantlement waste.

The nuclear facility dismantlement waste may include concrete and soil. In the case of concrete, the sizes of particles are large, and thus, it may be crushed to specific sizes through a crusher and then may be contained in a measurement container through a discharger. In the case of soil, it may be contained in a measurement container through a discharger.

Hereinafter, the radioactive waste contained in the measurement container is defined as an inspection target “T”.

### First Inspection Module 10 and Second Inspection Module 20

As illustrated in FIG. 2, the apparatus for classifying radioactive waste may include a first inspection module 10 and a second inspection module 20. The first inspection module 10 may be configured to measure whether an amount of radiation emitted by the inspection target “T” is less than or equal to a specific first reference amount. A first direction D1 may be a direction perpendicular to an up/down direction. As an example, the first reference amount may be 1 becquerel (Bq/g).

As an example, the first inspection module 10 may be configured to measure whether the amount of the radiation emitted by the inspection target “T” is less than or equal to the first reference amount while the inspection target “T” is moved along the first direction D1. This scheme may be understood as a scheme for a relatively high-speed inspection. However, the present disclosure is not necessarily limited thereto, and it may be possible to apply an inspection scheme of the second inspection module 20, which will be described later, to the first inspection module 10.

The second inspection module 20 may be configured to re-inspect the inspection target “T” and measure whether the amount of the radiation emitted by the inspection target “T” is less than or equal to the second reference amount when the amount of the radiation emitted by the inspection target “T”, which is measured by the first inspection module 10 is less than or equal to the first reference amount. The second reference amount may have a value that is smaller than the first reference amount. As an example, the second reference amount may be 0.1 becquerel (Bq/g).

As an example, the second inspection module 20 may be configured to measure whether the amount of the radiation emitted by the inspection target “T” for a reference time period is less than or equal to the second reference amount by locating the inspection target “T” in a second reference area in an interior of the second inspection module 20 for the reference time period. As an example, the reference time period may be 10 minutes. This scheme may be understood as a scheme for a relatively precise inspection. However, the present disclosure is not necessarily limited thereto, and it may be possible to apply the inspection scheme of the first inspection module 10 described above to the second inspection module 20.

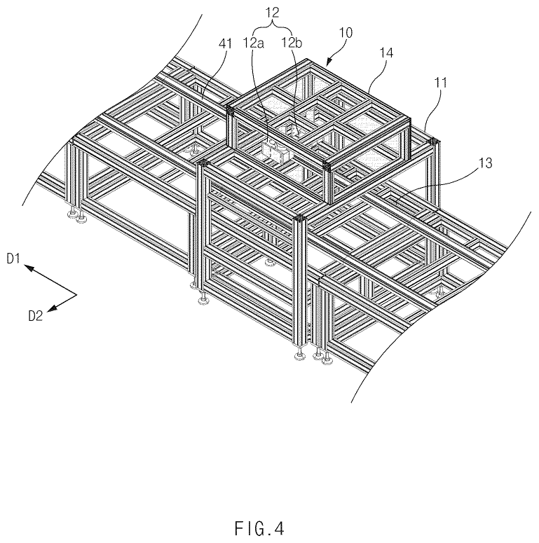

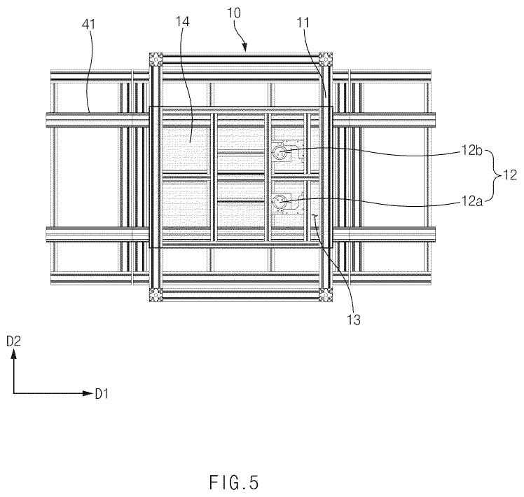

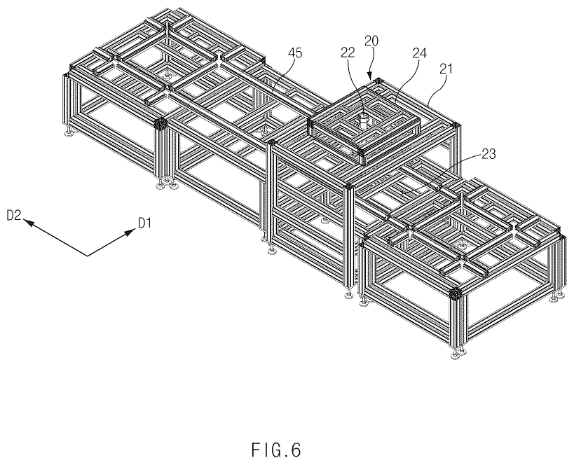

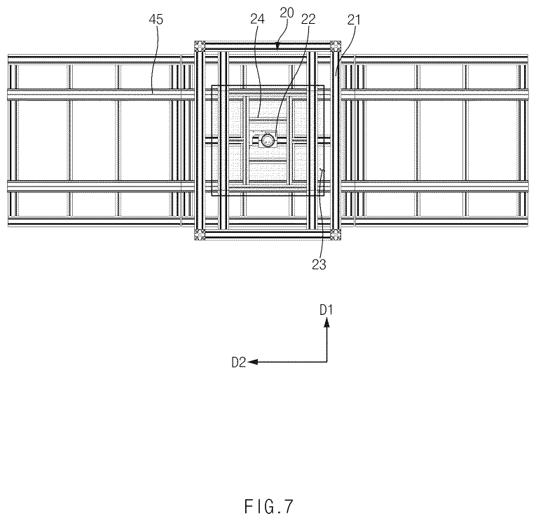

FIG. 4 is a perspective view of the first inspection module. FIG. 5 is a top view of the first inspection module. FIG. 6 is a perspective view of the second inspection module. FIG. 7 is a top view of the second inspection module. Hereinafter, the first inspection module 10 and the second inspection module 20 will be described in detail with reference to FIGS. 4 to 7.

The first inspection module 10 may include a first module body 11 and a first sensor part 12. The first module body 11 may include a first inspection passage 13. The first inspection passage 13 may extend along the first direction D1, and the inspection target “T” may pass through an interior thereof.

The first sensor part 12 may be located on a side of the first inspection passage 13 in the first direction D1, and may be configured to measure the amount of the radiation emitted by the inspection target “T”.

As an example, the first sensor part 12 may include a plurality of first sensor members. Then, the radionuclide measured by the first sensor members to measure the amount of the radiation may be the same. For example, the first sensor member may measure the amount of the radiation of at least any one of Cs-137 and Co-60.

The plurality of first sensor members may be arranged along a second direction D2 that is one direction that is perpendicular to the up/down direction and the first direction D1. When the amount of the radiation is measured, there is a possibility that a smaller amount of the radiation will be detected when the inspection target becomes more distant from the first sensor member. When the plurality of first sensor members are provided, a maximum spacing distance between one first sensor member and the inspection target “T” is reduced, and thus, a reliability of measurement may increase.

As another example, the first sensor part 12 may include a (1-1)-th sensor member 12a and a (1-2)-th sensor member 12b. As an example, the (1-1)-th sensor member 12a may be a NaI(Tl) scintillation detector. The (1-2)-th sensor member 12b may have an energy resolution that is higher than that of the (1-1)-th sensor member 12a.

Hereinafter, the effects that may be obtained as the first sensor part 12 includes the (1-1)-th sensor member 12a and the (1-2)-th sensor member 12b will be described in detail.

The NaI(Tl) scintillation detector has a high luminous efficiency by emitting up to 55,000 photons, and the flash extinction time is as short as about 250 ns, and thus, it is suitable for measuring and analyzing signals, for example, for a gamma ray measurement. Furthermore, because it began to be used in the 1950's and has been used by many researchers in various fields, its reliability has been proven, and thus, it is used as the most basic equipment in the field of measuring and analyzing radiation.

However, the disadvantage of the NaI(Tl) scintillation detector is a low energy resolution, and the resolution of radiation at 661.66 keV emitted from Cs-137 is about 7%, which is considerably lower compared to other scintillation materials. Low energy resolution means that it includes a relatively large background (environmental radiation) area, and that means that errors in measurement and analysis may increase.

As an example, when radiation of 661.66 keV emitted by Cs-137 in a random soil sample is to be measured, it may be assumed that this sample contains Bi-214. Because Bi-214 emits energy of 609 keV, the 609 keV energy of Bi-214 and the 661.66 keV energy of Cs-137 cannot be distinguished and may be formed in only one peak when being measured by using NaI(Tl) that has a low energy resolution. Because the values that have to be distinguished by forming the energy peaks are added together to form a single peak, serious coefficient errors may occur.

Then, the counting error may be reduced when another detector with a higher gamma-ray detection efficiency and an improved energy resolution compared to the NaI(Tl) scintillation detector is used.

The first inspection module 10 may further include a first shield part 14. The first shield part 14 may be configured to cover the first module body 11 to shield external radiation from being introduced into an inside of the first module body 11. Natural radiation may also exist outside the first inspection module 10. Then, when natural radiation is introduced into an interior of the first inspection module 10, problems may arise in the reliability of the values measured by the first inspection module 10, and thus, natural radiation is shielded through the first shield part 14.

The second inspection module 20 may include a second module body 21 and a second sensor part 22. The second module body 21 may include a second inspection passage 23. The second inspection passage 23 may extend along the second direction D2, and an inspection target “T” may pass through an interior thereof. Then, the inspection target “T” may pass in an opposite direction to the second direction D2.

The second sensor part 22 may be located at the center of the second inspection passage 23, and may be configured to measure the radiation emitted by the inspection target “T”. The second sensor part 22 may be a high-purity germanium (HPGe) detector with a built-in cooling device.

The second inspection module 20 may further include a second shield part 24. The second shield part 24 may be configured to cover the second module body 21 to shield external radiation from being introduced into an inside of the second module body 21.

Hereinafter, the remaining components of the apparatus for classifying radioactive waste according to an embodiment of the present disclosure will be described in detail.

### Pallet 30

The apparatus for classifying radioactive waste according to an embodiment of the present disclosure may further include a pallet 30. The pallet 30 may be configured such that the inspection target “T” is seated thereon. Although only one pallet 30 is illustrated in FIG. 3 for convenience of description, a plurality of pallets 30 may be provided as needed.

As an example, the pallet 30 may include a pallet body having a rectangular plate shape. Furthermore, a plurality of rollers 31 may be provided at a lower portion of the pallet body to be moved along a rail part 40 that will be described later. The roller 31 may be rotatable about an imaginary axis that extends along the up/down direction. Furthermore, the roller 31 may be moved forward and rearward.

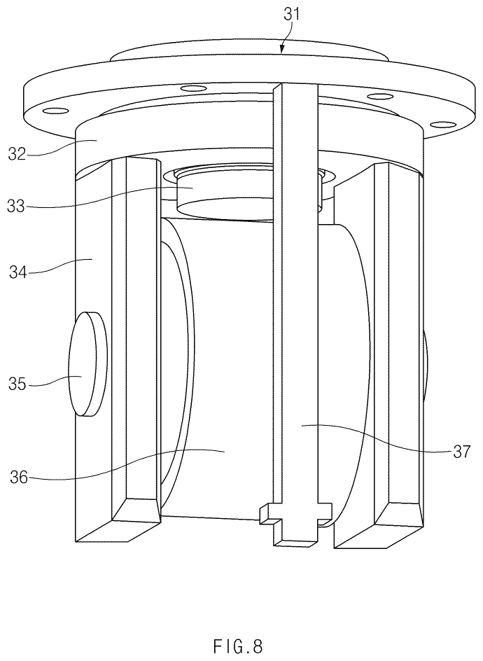

FIG. 8 is a perspective view illustrating the roller. As illustrated in FIG. 8, the roller 31 may include a housing head 32, a housing rotary shaft 33, a housing partition wall 34, a travel rotary shaft 35, a roller wheel 36, and a travel guide 37.

The housing head 32 may be located at a lower portion of the pallet body, and may be formed in a circular shape. The housing head 32 may be rotated about the housing rotary shaft 33. The housing rotary shaft 33 may extend in the up/down direction, and may pass through the housing head 32 to be coupled to a lower portion of the pallet body. The housing partition wall 34 may extend downward to provide a space for accommodating the roller wheel 36. The travel rotary shaft 35 may be coupled to the housing partition walls 34 at opposite ends thereof so that the roller wheel 36 may be rotated between the housing partition walls 34. The travel guide 37 may extend downward, and may be partially inserted into the rail part 40 that will be described later. As the travel guide 37 is partially inserted into the rail part 40, the pallet 30 may be guided to be moved according to a shape of the rail part 40.

### Rail Part 40

The apparatus for classifying radioactive waste according to an embodiment of the present disclosure may further include the rail part 40. The pallet 30 may be seated on the rail part 40 to be movable. As an example, the pallet 30 may be slid along the rail part 40.

The rail part 40 may include first to fifth rails 41, 42, 43, 44, and 45. The first to fifth rails 41, 42, 43, 44, and 45 described here are names that are given to the entire rail part 40 for the purpose of the movement path, and does not mean that they are used only when they are formed separately and are coupled to each other.

A first rail 41 may be a rail that extends in the first direction D1, and to which the first inspection module 10 is coupled. Here, the aspect that the first inspection module 10 is coupled may mean that there is an area that overlaps the first rail 41 and the first inspection module 10 when viewed from a top so that the inspection target “T” seated on the pallet 30 that is moved along the first rail 41 may be inspected by the first inspection module 10.

A second rail 42 may refer to a rail that extends along the first direction D1 from a distal end of the first rail 41 in the first direction D1.

A third rail 43 may extend along the second direction D2 from a distal end of the second rail 42 in the first direction D1.

A fourth rail 44 may extend along an opposite direction to the first direction D1 from a distal end of the third rail 43 in the second direction D2.

A fifth rail 45 may extend from a distal end of the fourth rail 44 in an opposite direction to the first direction D1 in an opposite direction to the second direction D2. Furthermore, the fifth rail 45 may be connected to the distal end of the first rail 41 in the first direction D1, and a second inspection module 20 may be coupled thereto. Here, the aspect that the second inspection 20 is coupled may mean that there is an area that overlaps the fifth rail 45 and the second inspection module 20 when viewed from a top so that the inspection target “T” seated on the pallet 30 that is moved along the fifth rail 45 is inspected by the second inspection module 20.

Furthermore, the rail part 40 may include sixth and seventh rails 46 and 47. A sixth rail 46 may extend from a distal end of the fourth rail 44 in an opposite direction to the first direction D1, in the opposite direction to the first direction D1. The seventh rail 47 may extend from the distal end of the sixth rail 46 in the opposite direction to the first direction D1, in the direction opposite to the second direction D2, and may be connected to the first rail 41. Overall, a shape of the rail part 40 may be similar to a shape of a Chinese character that means the Sun, which is rotated by 90 degrees.

### Motor Part

The apparatus for classifying radioactive waste according to an embodiment of the present disclosure may include a motor part (not illustrated) that is coupled to the pallet 30 and is configured to move the pallet 30. As an example, the motor part may be a linear motor.

The motor part may be disposed on a motor rail. The motor rail may be spaced apart from the rail part 40 at regular intervals, and may have a lattice structure. A plurality of motor parts may be disposed on the motor rail to generate a driving force for feeding the pallet 30.

In more detail, each of the plurality of motor parts may further include a linear motor coil for reacting a reaction member that is mounted on the pallet 30, and a pair of impact preventing boards that are disposed on front and rear sides to prevent an impact between the adjacent pallets 30. Furthermore, a position detecting Hall sensor for detecting a position of the pallet 30 may be formed on one or more of the plurality of motor parts and the motor rail.

The motor part may be a linear synchronous motor. Then, the pallet 30 may be moved in a long stator manner. In more detail, by installing the coil part corresponding to a stator of a rotary synchronous motor on the motor rail and installing the magnetic part corresponding to a rotor on the pallet 30, a driving force may be generated by the repulsive force.

However, the present disclosure is not limited thereto, and the motor part may be a linear induction motor.

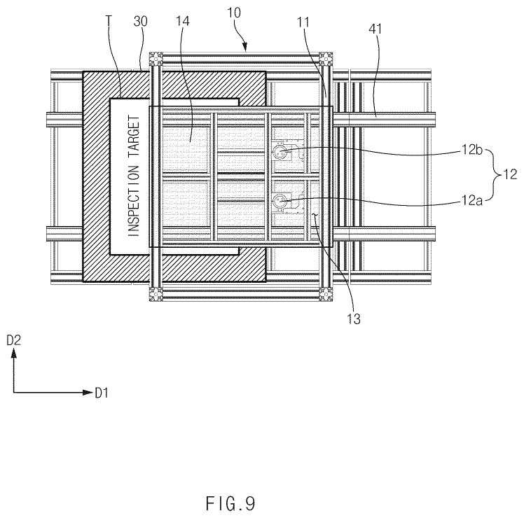

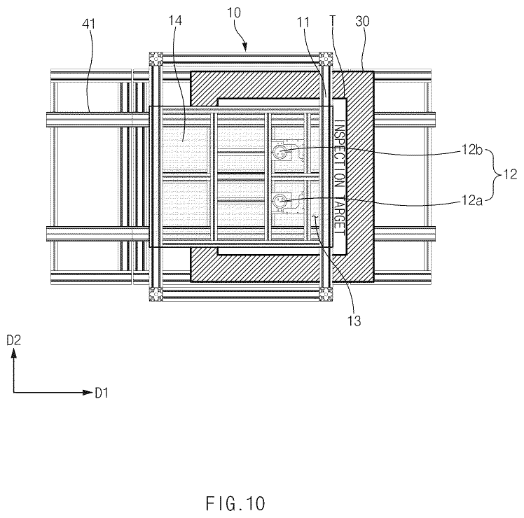

FIG. 9 is a view illustrating a case, in which the inspection target is not in the first reference area. FIG. 10 is a view illustrating a case, in which the inspection target is in the first reference area.

The motor part may move the pallet 30 at the first movement speed before the pallet 30 or the inspection target “T” seated on the pallet 30 is located in the first reference area in an interior of the first inspection module 10. The first reference area may refer to a position, in which the pallet 30 or the inspection target “T” seated on the pallet 30 overlaps a sensing area of the first sensor part 12.

As an example, the first reference area may refer to an area from a distal end of the pallet 30 or the inspection target “T” seated on the pallet 30 in an opposite direction to the first reference direction D1 when the first sensor part 12 and the pallet 30 or the inspection target “T” seated on the pallet 30 start to overlap each other on the first rail 41, or from a distal end of the pallet 30 or the inspection target “T” seated in the pallet 30 in an opposite direction to the first reference direction D1 to a distal end of the pallet 30 or the inspection target “T” seated on the pallet 30 in the first reference direction D1 when the overlapping of the first sensor part 12 and the pallet 30 or the inspection target “T” seated on the pallet 30 is ended.

However, this is only an example, and the first reference area may be set within various ranges considering the size of the sensing area of the first sensor part 12, and the like.

Furthermore, the motor part may move the pallet 30 at a second movement speed when the pallet 30 or the inspection target “T” seated on the pallet 30 is located in the first reference area. The first movement speed may be higher than the second movement speed. This may mean that the motor part moves the pallet 30 at a relatively high speed when the pallet 30 passes through an area unrelated to the inspection, and the motor part moves the pallet 30 at a relatively low speed when the pallet 30 passes through an area related to inspection.

To perform the inspection quickly, it is necessary to move the pallet 30 at a high speed, but a sufficient speed for detecting the amount of radiation may be necessary when the inspection is performed, and thus, the motor part may move the pallet 30 at a relatively high speed when the pallet 30 passes through an area unrelated to the inspection and the motor part may move the pallet 30 at a relatively low speed when the pallet 30 passes through an area related to the inspection. Thereafter, after the pallet 30 passes the first inspection module 10, the motor part may move the pallet 30 again at the first movement speed.

### Storage Part 50 and Feeding Crane 60

As illustrated in FIG. 2, the apparatus for classifying radioactive waste according to an embodiment of the present disclosure may further include a storage part 50 and a feeding crane 60. The storage part 50 may be located to be spaced apart from a side of the third rail 43 in the first direction D1, and may be configured to store the inspection target “T”, of which the amount of the radiation has been measured.

The feeding crane 60 may be disposed between the third rail 43 and the storage part 50, and may be configured to feed the inspection target “T” seated on the pallet 30 located on the third rail 43 to the storage part 50. The feeding crane 60 may be moved along the second direction D2 and the opposite direction thereto. As an example, the feeding crane 60 may be seated on a feeding rail 61 that extends in the second direction D2 to be slid.

Furthermore, the feeding crane 60 may move the inspection target “T” upward and downward. As the feeding crane 60 may be moved along the second direction D2 and the opposite direction thereto and is formed to move the inspection target “T” upward and downward, the inspection target “T” may be stored in a specific position of the storage part 50.

Meanwhile, the storage part 50 may include a first storage area 51 and a second storage area 52. The first storage area 51 may be an area that is configured such that the inspection target “T”, of which the amount of the emitted radiation is more than the second reference amount, is stored. The first storage area 51 may be an area for storing radioactive waste that cannot be self-disposed.

The second storage area 52 may be an area that is configured such that the inspection target “T”, of which the amount of the emitted radiation is less than or equal to the second reference amount, is stored. The second storage area 52 may be an area for storing the radioactive waste that is subject to self-disposal.

### Operation of Apparatus for Classifying Radioactive Waste

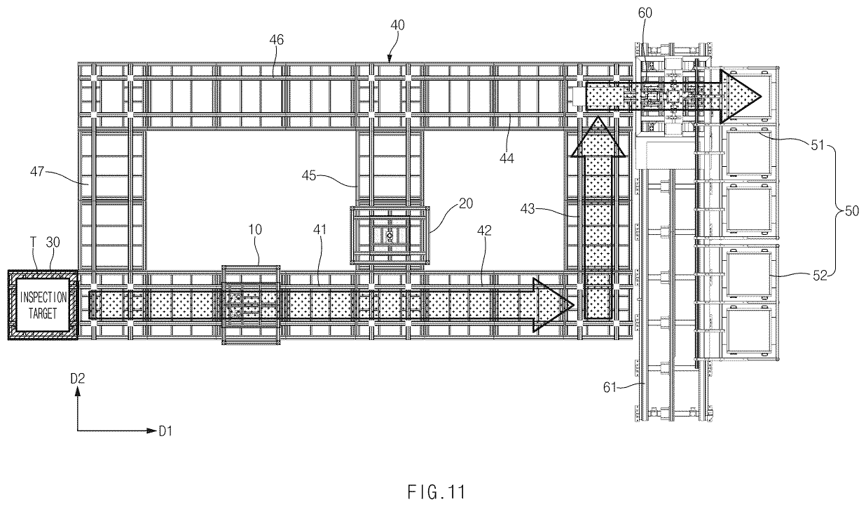

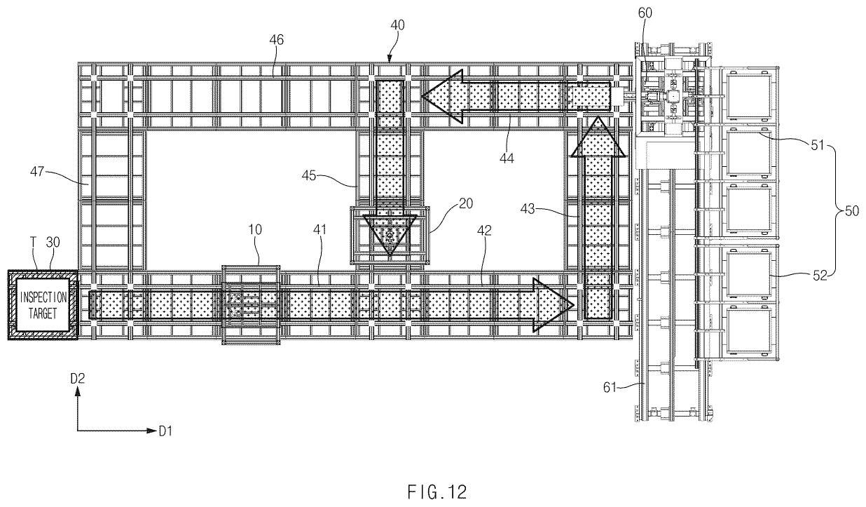

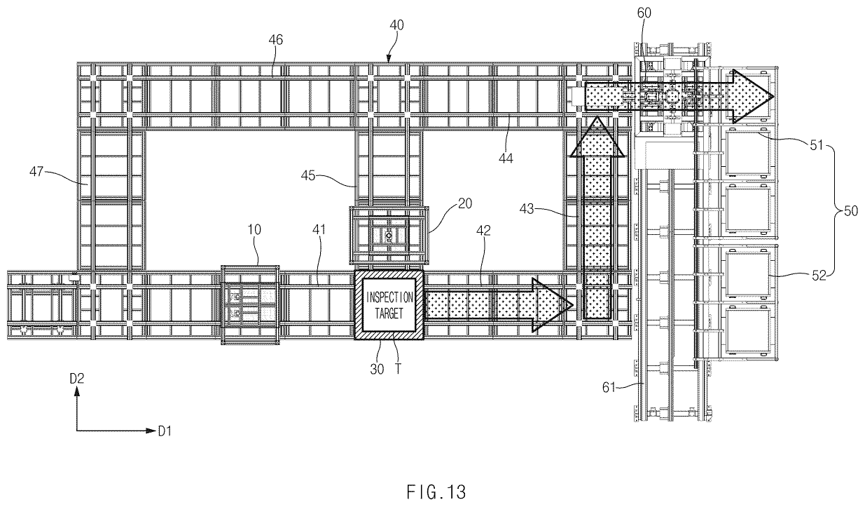

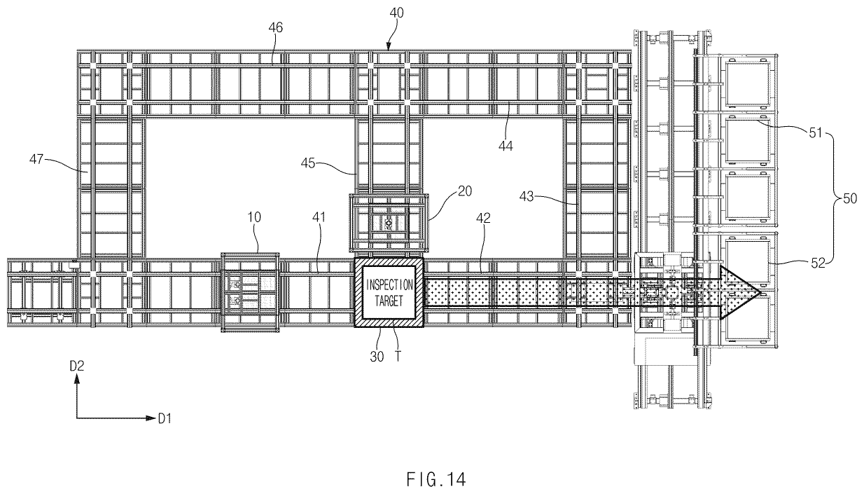

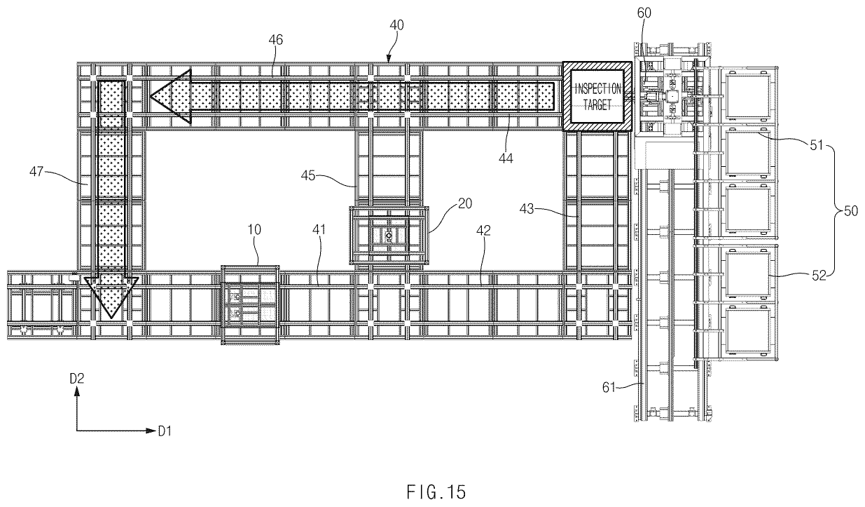

Hereinafter, an operation of the apparatus for classifying radioactive waste will be described in detail. FIG. 11 is a view illustrating the movement path of the pallet when the amount of the radiation of the inspection target is more than the first reference amount. FIG. 12 is a view illustrating the movement path of the pallet when the amount of the radiation of the inspection target is less than or equal to the first reference amount. FIG. 13 is a view illustrating the movement path of the pallet when the amount of the radiation of the inspection target is more than the second reference amount. FIG. 14 is a view illustrating the movement path of the pallet when the amount of the radiation of the inspection target is less than or equal to the second reference amount. FIG. 15 is a view illustrating the movement path of the pallet after the inspection target has been stored.

As illustrated in FIG. 11, the amount of the radiation emitted by the inspection target “T” seated on the pallet 30, which is measured by the first inspection module 10, is more than the reference amount when the pallet 30 passes the first rail 41, the inspection target “T” may pass through the second rail 42 while being seated on the pallet 30, and then may be stored in the first storage area 51 through the feeding crane 60. Because the first reference amount is greater than the second reference amount, it may be considered that the radioactive waste cannot be self-disposed with no need to go through the second inspection module 20 when the amount of the radiation emitted by the inspection target “T” is more than the first reference amount. Then, the inspection target “T” may be stored in the first storage area 51 through the feeding crane 60 via the second rail 42. Then, the inspection target “T” may partially pass through the third rail 43 when necessary.

As illustrated in FIG. 12, when the amount of the radiation emitted by the inspection target “T” seated on the pallet 30, which is measured by the first inspection module 10, is less than the first reference amount when the pallet 30 passes the first rail 41, the inspection target “T” may pass through the second rail 42, third rail 43, fourth rail 44, and fifth rail 45 while being seated on the pallet 30. This may mean that the inspection target “T” needs to be inspected precisely.

The second inspection module 20 may measure whether the amount of the radiation emitted by the inspection target “T” when the inspection target “T” passes the fifth rail 45 is less than or equal to the second reference amount. As illustrated in FIG. 13, when the amount of the radiation emitted by the inspection target “T”, which is measured by the second inspection module 20, is more than the second reference amount, the inspection target “T” may pass via the rail 42 while being seated on the pallet 30, and then, may be stored in the first storage area 51 through the feeding crane 60. In this case, because the inspection target “T” is radioactive waste that cannot be self-disposed, it may be stored in the first storage area 51. Then, the inspection target “T” may partially pass via the third rail 43 when necessary.

As illustrated in FIG. 14, when the radiation emitted by the inspection target “T”, which is measured by the second inspection module 20, is less than or equal to the second reference amount, the inspection target “T” may pass via the second rail 42 while being seated on the pallet 30 and, and then, may be stored in the second storage area 52 through the feeding crane 60. Then, the inspection target “T” may partially pass via the third rail 43 when necessary.

Meanwhile, as illustrated in FIG. 15, the pallet 30 that has delivered the inspection target “T” to the feeding crane 60 may be moved to the first rail 41 via the fourth rail 44, the sixth rail 46, and the seventh rail 47. Through this process, it may be seen that the pallet 30 is ready to transport another inspection target “T”.

The apparatus for classifying radioactive waste according to an embodiment of the present disclosure may further include a decontamination part (not illustrated). The decontamination part may be coupled to the rail part 40, and may be configured to decontaminate the inspection target “T” seated on the pallet 30. The decontamination part may use at least one of methods, such as acid washing, water washing, or electrolytic polishing.

As an example, the decontamination part may be coupled to the second rail 42, and may decontaminate the inspection target “T” and lower the amount of the radiation emitted by the inspection target “T” below the second reference amount when the amount of the radiation detected by the second inspection module 20 slightly exceeds the second reference amount.

As another example, the decontamination part may be coupled to the second rail 42, and may decontaminate the inspection target “T” to lower the amount of the radiation emitted by the inspection target “T” bellows the first reference amount when the amount of the radiation detected by the first inspection module 10 slightly exceeds the first reference amount.

As another example, the decontamination part may be coupled to the second rail 42 and may repeatedly decontaminate the inspection target “T” to lower the amount of the radiation emitted by the inspection target “T” below the second reference amount.

### System for Classifying Nuclear Facility Dismantlement Waste

Hereinafter, a system for classifying nuclear facility dismantlement waste including the above-described apparatus for classifying radioactive waste will be described in detail based on the above-described contents and drawings. The contents regarding the apparatus for classifying radioactive waste has been described above, and a detailed description thereof will be omitted.

The system for classifying nuclear facility dismantlement waste may include the apparatus for classifying radioactive waste, and a controller 70 (FIG. 2).

The apparatus for classifying radioactive waste may be configured to measure an amount of radiation of nuclear facility dismantlement waste that is waste generated when a nuclear facility is dismantled, and classify the nuclear facility dismantlement waste according to a specific standard.

The controller 70 may be configured to control the apparatus for classifying radioactive waste. As an example, the controller 70 may be configured to control performance of the inspection by the first inspection module 10. As another example, the controller 70 may be configured to control the performance of the inspection by the second inspection module 20. As another example, the controller 70 may be configured to control the movement of the pallet 30 by controlling the motor part.

The controller 70 may include a processor 71 and a memory 72. The processor 71 may include a microprocessor, such as a field programmable gate array (FPGA), an application specific integrated circuit (ASIC), or a central processing unit (CPU). The memory 72 may store control instructions that are the basis for generating instructions for determining whether the apparatus for classifying radioactive waste is operated, by the processor 71. The memory 72 may be a data storage, such as a hard disk drive (HDD), a solid state drive (SSD), a volatile medium, or a non-volatile medium.

The apparatus for classifying radioactive waste may include the first inspection module 10, the second inspection module 20, and the storage part 50. The first inspection module 10 may be configured to measure whether the amount of the radiation emitted by the nuclear facility dismantlement waste is less than or equal to a specific first reference amount.

The second inspection module 20 may be configured to re-inspect the nuclear facility dismantlement waste and measure whether the amount of the radiation emitted by the nuclear facility dismantlement waste is less than or equal to the second reference amount that is smaller than the first reference amount when the amount of the radiation emitted by the nuclear facility dismantlement waste, which is measured by the first inspection module 10, is less than or equal to the first reference amount.

The storage part 50 may be configured to classify and store nuclear facility dismantlement waste based on the inspection results of the first inspection module 10 and the second inspection module 20.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

1. An apparatus for classifying radioactive waste, the apparatus comprising:
a first inspection module configured to measure whether an amount of radiation emitted by an inspection target is less than or equal to a first reference amount while the inspection target is moved along a first direction being one direction being perpendicular to an up/down direction; and
a second inspection module configured to measure whether an amount of radiation emitted by the inspection target is less than or equal to a second reference amount being smaller than the first reference amount by re-inspecting the inspection target when the amount of the radiation emitted by the inspection target, which is measured by the first inspection module, is less than or equal to the first reference amount.

2. The apparatus of claim 1, wherein the first inspection module includes:
a first module body extending along the first direction, and including a first inspection passage configured such that the inspection target passes through an interior thereof; and
a first sensor part located a side of the first inspection passage in the first direction, and configured to measure the amount of the radiation emitted by the inspection target.

3. The apparatus of claim 2, wherein the first sensor part includes:
a plurality of first sensor members arranged along a second direction being one direction being perpendicular to the up/down direction and the first direction.

4. The apparatus of claim 2, wherein the first sensor part includes:
a (1-1)-th sensor member; and
a (1-2)-th sensor member having an energy resolution being higher than that of the (1-1)-th sensor member.

5. The apparatus of claim 2, wherein the first inspection module further includes:
a first shield part covering the first module body, and configured to shield external radioactive rays from being introduced to an inside of the first module body.

6. The apparatus of claim 1, wherein the second inspection module is configured to:
locate the inspection target in a second reference area in an interior of the second inspection module for a reference time period to measure an amount of radiation emitted by the inspection target for the reference time period is less than or equal to the second reference amount.

7. The apparatus of claim 1, further comprising:
a pallet configured such that the inspection target is seated thereon; and
a rail part configured such that the pallet is seated thereon to be movable.

8. The apparatus of claim 7, further comprising:
a motor part coupled to the pallet and configured to move the pallet,
wherein the motor part is configured to:
move the pallet at a first movement speed before the pallet or the inspection target seated on the pallet is located in a first reference area in an interior of the first inspection module; and
move the pallet at a second movement speed being lower than the first movement speed when the pallet or the inspection target seated on the pallet is located in the first reference area.

9. The apparatus of claim 7, wherein the rail part includes:
a first rail extending in the first direction, and to which the first inspection module is coupled;
a second rail extending along the first direction from a distal end of the first rail in the first direction;
a third rail extending along a second direction being one direction being perpendicular to the up/down direction and the first direction from a distal end of the second rail in the first direction;
a fourth rail extending along an opposite direction to the first direction from a distal end of the third rail in the second direction; and
a fifth rail extending in an opposite direction to the second direction from a distal end of the fourth rail in an opposite direction to the first direction, connected to the distal end of the first rail in the first direction, and to which the second inspection module is coupled.

10. The apparatus of claim 9, further comprising:
a storage part located on a side of the third rail in the first direction to be spaced apart from the third rail, and configured to store the inspection target, of which the amount of the radiation has been measured; and
a feeding crane disposed between the third rail and the storage part, and configured to feed the inspection target seated on the pallet located on the third rail to the storage part.

11. The apparatus of claim 10, wherein the storage part includes:
a first storage area configured to store, among the inspection targets, an inspection target, of which an amount of emitted radiation is more than the second reference amount; and
a second storage area configured to store, among the inspection targets, an inspection target, of which an amount of emitted radiation is less than or equal to the second reference amount.

12. The apparatus of claim 11, wherein when the amount of radiation emitted by the inspection target seated on the pallet, which is measured by the first inspection module, is more than the first reference amount when the pallet passes via the first rail,
the inspection target is stored in the first storage area through the feeding crane after being seated on the pallet and passing by the second rail.

13. The apparatus of claim 11, wherein when the amount of the radiation emitted by the inspection target seated on the pallet, which is measured by the first inspection module, is less than or equal to the first reference amount when the pallet passes via the first rail,
the inspection target is seated on the pallet and passes via the second rail, the third rail, the fourth rail, and the fifth rail, and wherein the second inspection module measures whether the amount of
radiation emitted by the inspection target is less than or equal to the second reference amount when the inspection target passes via the fifth rail.

14. The apparatus of claim 13, wherein when the amount of the radiation emitted by the inspection target, which is measured by the second inspection module, is more than the second reference amount,
the inspection target is stored in the first storage area through the feeding crane after being seated on the pallet and passing by the second rail.

15. The apparatus of claim 14, wherein when the amount of the radiation emitted by the inspection target, which is measured by the second inspection module, is less than or equal to the second reference amount,
the inspection target is stored in the second storage area through the feeding crane after being seated on the pallet and passing by the second rail.

16. The apparatus of claim 10, wherein the rail part further includes:
a sixth rail extending in an opposite direction to the first direction from a distal end of the fourth rail in the opposite direction to the first direction; and
a seventh rail extending in an opposite direction to the second direction from a distal end of the sixth rail in the opposite direction to the first direction, and connected to the first rail, and
wherein the pallet having delivered the inspection target to the feeding crane is moved to the first rail via the fourth rail, the sixth rail, and the seventh rail.

17. The apparatus of claim 7, further comprising:
a decontamination part coupled to the rail part, and configured to decontaminate the inspection target seated on the pallet.

18. A system for classifying nuclear facility dismantlement waste, the system comprising:
a radioactive waste classifying apparatus configured to measure an amount of radiation of nuclear facility dismantlement waste being waste generated when a nuclear facility is dismantled to classify the nuclear facility dismantlement waste; and
a controller configured to control the radioactive waste classifying apparatus,
wherein the radioactive waste classifying apparatus includes:
a first inspection module configured to measure whether an amount of the radiation emitted by the nuclear facility dismantlement waste is less than or equal to a first reference amount;
a second inspection module configured to measure whether the amount of the radiation emitted by the nuclear facility dismantlement waste is less than or equal to a second reference amount being smaller than the first reference amount by re-inspecting the nuclear facility dismantlement waste when the amount of the radiation emitted by the nuclear facility dismantlement waste, which is measured by the first inspection module, is less than or equal to the first reference amount; and
a storage part configured to classify and store the nuclear facility dismantlement waste based on inspection results of the first inspection module and the second inspection module.
